(19) United States
(12) Patent Application Publication
(10) Pub. No.: US 2009/0107972 A1
(43) Pub. Date: Apr. 30, 2009

(54) HEATING UNIT FOR WARMING PROPANE TANKS

(76) Inventors: David Naylor, Draper, UT (US); Thomas Caterina, Boise, ID (US)

Correspondence Address: Workman Nydegger;1000 Eagle Gate Tower, 60 East South Temple, Salt Lake City, UT, 84111, US

(21) Appl. No.: 12/264,493

(22) Filed: Nov. 4, 2008

Related U.S. Application Data
(63) Continuation-in-part of application No. 11/835,641, filed on Aug. 8, 2007.
Application No. 11/835,641 is a continuation-in-part of application No. 11/744,163, filed on May 3, 2007.
Application No. 11/744,163 is a continuation-in-part of application No. 11/218,156, filed on Sep. 1, 2005, now Pat. No. 7,230,213.
Application No. 11/218,156 is a continuation-in-part of application No. 11/422,580, filed on Jun. 6, 2006.
Application No. 11/422,580 is a continuation-in-part of application No. 11/218,156, filed on Sep. 1, 2005, now Pat. No. 7,230,213.
Application No. 11/422,580 is a continuation-in-part of application No. 11/344,830, filed on Feb. 1, 2006, now Pat. No. 7,183,524.
Application No. 11/344,830 is a continuation-in-part of application No. 11/218,156, filed on Sep. 1, 2005, now Pat. No. 7,230,213.
(60) Provisional application No. 60/688,146, filed on Jun. 6, 2005.
(60) Provisional application No. 60/654,702, filed on Feb. 17, 2005.
(60) Provisional application No. 60/656,060, filed on Feb. 23, 2005.
(60) Provisional application No. 60/688,146, filed on Jun. 6, 2005.
(60) Provisional application No. 60/654,702, filed on Feb. 17, 2005.
(60) Provisional application No. 60/656,060, filed on Feb. 23, 2005.
(60) Provisional application No. 60/688,146, filed on Jun. 6, 2005.

(51) Int. Cl. H05B 3/34

(52) U.S. Cl. 219/162; 219/528

(57) ABSTRACT

A heating unit for use in heating a propane tank is disclosed. The heating unit includes a first pliable cover layer and a second pliable cover layer. A pliable electrical heating element is disposed between the first and the second cover layers. The pliable electrical heating element includes a heat generating element for converting electrical energy to heat energy and a heat spreading element that is attached to the heat generating element. The heat spreading element comprises carbon that is thermally coupled to the heat generating element for distributing the heat energy. A thermal insulation layer is attached to a second side of the pliable electrical heating element and is positioned adjacent the first cover layer. Additionally, a receiving power connector is electrically connected to the heat generating element and is configured to couple to an electrical power source. The heating unit is sized to substantially cover the sides and one or both ends of a propane tank.

### CROSS-REFERENCE TO RELATED APPLICATIONS

This application is a continuation in part of co-pending U.S. application Ser. No. 11/835,641 filed on Aug. 8, 2007 titled GROUNDED MODULAR HEATED COVER, which is a continuation in part of U.S. patent application Ser. No. 11/744,163 filed May 3, 2007, which is a continuation in part of U.S. patent application Ser. No. 11/218,156 filed Sep. 1, 2005, now U.S. Pat. No. 7,230,213, issued on Jun. 12, 2007. This application is also a continuation in part of co-pending U.S. application Ser. No. 11/422,580 filed on Jun. 6, 2006, titled “A RADIANT HEATING APPARATUS” which claims priority to U.S. Provisional Patent Application 60/688,146 filed Jun. 6, 2005, titled LAMINATE HEATING APPARATUS. U.S. application Ser. No. 11/422,580 filed on Jun. 6, 2006, titled “A RADIANT HEATING APPARATUS” is a Continuation in Part of U.S. patent application Ser. No. 11/218,156, filed Sep. 1, 2005, now U.S. Pat. No. 7,230,213 issued on Jun. 12, 2007, which claims priority to: U.S. Provisional Patent Application 60/654,702 filed on Feb. 17, 2005, titled A MODULAR ACTIVELY HEATED THERMAL COVER; U.S. Provisional Patent Application 60/656,060 filed Feb. 23, 2005 titled A MODULAR ACTIVELY HEATED THERMAL COVER; and U.S. Provisional Patent Application 60/688,146 filed Jun. 6, 2005, titled LAMINATE HEATING APPARATUS. U.S. application Ser. No. 11/422,580 filed on Jun. 6, 2006, titled “A RADIANT HEATING APPARATUS” is also a Continuation in Part of U.S. patent application Ser. No. 11,344,830, filed Feb. 1, 2006 now U.S. Pat. No. 7,183,524 issued on Feb. 27, 2007, which claims priority to: U.S. Provisional Patent Application 60/654,702 filed on Feb. 17, 2005, titled A MODULAR ACTIVELY HEATED THERMAL COVER; U.S. Provisional Patent Application 60/656,060 filed Feb. 23, 2005 titled A MODULAR ACTIVELY HEATED THERMAL COVER; and U.S. Provisional Patent Application 60/688,146 filed Jun. 6, 2005, titled LAMINATE HEATING APPARATUS. U.S. patent application Ser. No. 11,344,830, filed Feb. 1, 2006 now U.S. Pat. No. 7,183,524 issued on Feb. 27, 2007, is also a Continuation in Part of U.S. patent application Ser. No. 11/218,156, filed Sep. 1, 2005, now U.S. Pat. No. 7,230,213 issued on Jun. 12, 2007. Each of the preceding United States patent applications and patents is incorporated herein in its entirety by this reference.

### BACKGROUND

### Background and Relevant Art

The ability to distribute heat has provided a number of opportunities for increasing human comfort levels for certain activities and has made other activities not previously feasible able to be accomplished. One field where external heating has found particular use is in industries where individuals work with liquid or gaseous materials. For example, when using gaseous fuel supplies, such as propane, the fuel will typically need to be maintained within a certain temperature range to prevent the fuel from changing to its liquid form. Other individuals may need to work with materials at a given temperature where the materials are stored in various buckets, barrels, tanks, and the like.

Heating units of various types have been previously implemented for heating a variety of containers, including buckets and barrels. Typically bucket and barrel warmers are relatively long, narrow straps that wrap around a bucket or barrel to provide heat to the container and its contents. However, typical warmers only cover a portion of the container's wall. Warmers constructed in this fashion rely on the conductive nature of the metallic container to distribute heat to the contents of the container. However, these types of warmers typically result in overheating materials at the location of the warmer while possibly under heating materials in other portions of the container. In particular, temperatures up to 400° F. may be obtained at the heating elements of the warmer. This can be a fire hazard depending on the materials used in the warmer, or materials placed near a container being heated. To regulate the heat of materials in the container, the user may be required to stir the materials in the container so as to evenly mix different temperature materials. Additionally, if more even heat distribution is desired, multiple warmers may be required. However, this requires the availability of multiple outlet receptacles and the use of additional power.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described herein is directed to a heating unit for use in providing evenly distributed heat to a propane tank. The heating unit includes a first pliable cover layer and a second pliable cover layer. A pliable electrical heating element is disposed between the first and the second cover layers. The pliable electrical heating element includes a heat generating element for converting electrical energy to heat energy and a heat spreading element that is attached to the heat generating element. The heat spreading element comprises carbon that is thermally coupled to the heat generating element for distributing the heat energy. A thermal insulation layer is attached to a first side of the pliable electrical heating element and is positioned adjacent the first cover layer. Additionally, a receiving power connector is electrically connected to the heat generating element and is configured to couple to an electrical power source. The heating unit further includes one or more fasteners. The one or more fasteners are disposed in the first and second pliable cover layers in a fashion allowing the heating unit to be wrapped and secured around a propane tank. The heating unit is sized to cover substantially the entire outer circumference of a propane tank wall. The heating unit can also include one or two closable cap portions for covering substantially one or both ends of the propane tank.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an exemplary embodiment of a heating unit according to the present invention;

FIG. 2 illustrates a partially exploded view of the heating unit of FIG. 1;

FIG. 3 illustrates an exploded view of some of the components of the heating unit of FIG. 1 showing the construction of the heating unit with adhesive layers;

FIG. 4 illustrates details of a heat spreading element of the heating unit of FIG. 1;

FIGS. 5A and 5B illustrate comparative alternate temperature arrangements for the heating unit of FIG. 1:

FIGS. 6A and 6B illustrate various fasteners and closure mechanisms used in association with the heating unit of FIG. 1.

### DETAILED DESCRIPTION

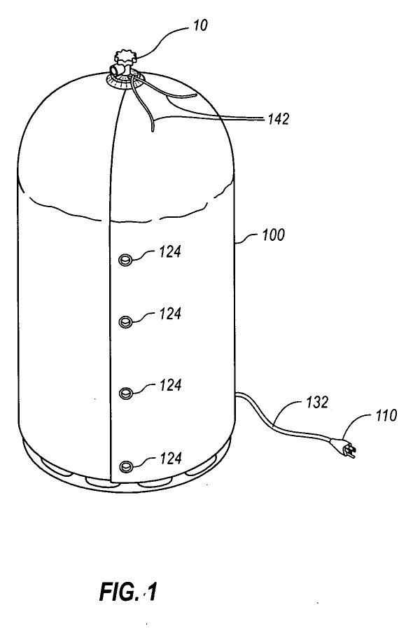

Disclosed herein are embodiments of a heating unit for use in propane tank warming applications. In particular, embodiments may include a heating unit configured to substantially cover the entire outer surface of a propane tank, including substantially the full circumference and one or both ends of the propane tank. The heating unit includes a heating element which provides heat and spreads the heat over the surface of the heating unit. The heating unit may also include an insulation layer to prevent heat from being lost to an environment external to the propane tank. For example, FIG. 1 illustrates one embodiment of a heating unit configured as a propane tank warmer 100 covering a propane tank 10. While FIG. 1 illustrates the heating unit as a propane tank warmer, it will be appreciated that the heating unit can be sized, shaped, or otherwise configured to provide heat to other types of tanks, buckets, barrel, or similar objects.

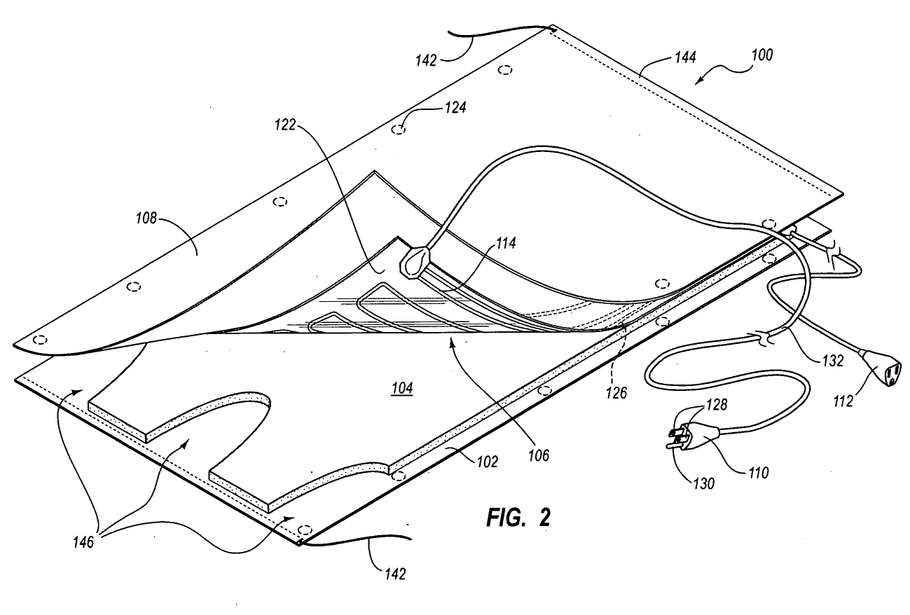

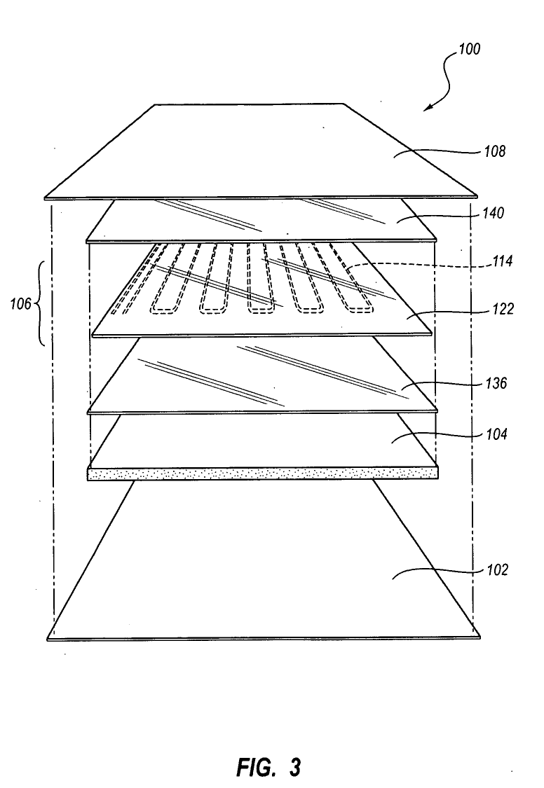

An example of components implemented in one embodiment is illustrated in FIGS. 2 and 3. These Figures illustrate the construction of the heating unit, including materials used to assemble the heating unit. FIG. 2 illustrates a partially exploded view illustrating the flexible nature of a heating unit 100 that includes a first cover layer 102, an insulation layer 104, a heating element 106, and a second cover layer 108. In some embodiments, the heating element 106 includes a heat generating strip 114 and a heat spreading element 122, each of which will be described in greater detail below. The heating unit 100 further includes an incoming electrical connector 110. The heating unit can also include an outgoing electrical connector 112. While the example illustrated in FIG. 2 is illustrated as partially exploded, some finished embodiments may be manufactured such that the insulation layer 104 and the heating element 106 may be sealed between the first cover layer 102 and the second cover layer 108. Sealing processes and details will be discussed in more detail below.

FIG. 3 illustrates a fully exploded view of the heating unit 100 so as to more clearly illustrate the individual components of the heating unit 100. As illustrated in FIG. 3, first and second cover layers 102 and 108 are generally planar sheets of material that are disposed on opposing sides of the internal components of heating unit 100. During construction of heating unit 100, first cover layer 102 is positioned as illustrated in FIG. 3. Next, insulation layer 104 is positioned on top of first cover layer 102 and heating element 106 is then positioned on top of insulation layer 104. Finally, second cover layer 108 is positioned on top of heating element 106. With the various components of heating unit 100 so positioned, the peripheral edges of first and second layers 102 and 108 can be joined, sealed, or otherwise closed.

Heating unit 100, constructed as described herein, can be used in numerous applications that require heat to be transferred to an object or surface. As described herein, the various components of heating unit 100 are flexible such that heating unit 100 can be wrapped around objects, laid on top, beneath, or hung adjacent objects or surfaces, and rolled or folded up when not in use. In order to ensure that heating unit 100 and its various components retain their shape and their positions relative to one another, the various components of heating unit 100 can be attached to one another. For example, the various components of heating unit 100 can be glued, bonded, or otherwise held together. Attaching the components of heating unit 100 together helps to prevent the components from moving relative to one another within heating unit 100.

For example, attaching heating element 106 to insulation layer 104 ensures that heating element 106 will stay positioned next to insulation layer 104 and will not sag, bunch, or otherwise move within heating unit 100. In particular, because insulation layer 104 is formed of a stiffer material than heating element 106, attaching heating element 106 to insulation layer 104 provides stiffness to heating element 106. While insulation layer 104 is referred to as being formed of a “stiffer” material, it will be appreciated that in some embodiments insulation layer 104 may still be flexible such that it can be wrapped around a barrel or folded around a box, for example. Similarly, heat generating strip 114 and heat spreading element 122 can be attached to one another to ensure that heat generating strip 114 is properly positioned on heat spreading element 122, even after heating unit 100 is rolled, folded, and used several times. Likewise, heating element 106 and/or insulation layer 104 can be attached to first and/or second cover layers 102 and 108 to prevent the internal components of heating unit 100 from moving within first and second cover layers 102 and 108.

FIG. 3 illustrates one exemplary embodiment in which various components of heating unit 100 are attached together. For convenience of illustration, incoming electrical connector 110 and outgoing electrical connector 112 are omitted from FIG. 3. In the embodiment illustrated in FIG. 3, there are two interfaces between the heating unit components for attachment between the components. As used herein, an attachment interface is a surface where two or more components of heating unit 100 are attached together. The first attachment interface 136 is between the top surface of insulation layer 104 and the bottom surface of heating element 106. As noted herein, heating element 106 includes a heat generating strip 114 mounted on a heat spreading element 122. In the illustrated embodiment, the heat generating strip 114 is mounted on the bottom surface of heat spreading element 122 such that heat generating strip 114 is positioned between heating spreading element 122 and insulation layer 104. Attachment interface 136 is therefore between the top surface of insulation layer 104 and the bottom surface of heat spreading element 122, with heat generating element 114 mount on heat spreading element 122 therebetween.

The second attachment interface 140 is between the top surface of heat spreading element 122 and the bottom surface of second cover layer 108. In other embodiments, there is only the first attachment interface 136. Still in other embodiments, there are additional attachment interfaces, such as between the bottom surface of insulation layer 104 and the top surface of first cover layer 102.

Attachment interfaces 136 and 140 can be created by attaching the above identified components of heating unit 100 in any suitable manner so that the components maintain their relative positions one to another. In one exemplary embodiment, attachment interfaces 136 and 140 are created using an adhesive between the components of heating unit 100. One such adhesive suitable for attaching together the components of heating unit 100 is 30-NF FASTBOND™ available from 3M located in St. Paul, Minn. FASTBOND™ is a non-flammable, heat resistant, polychloroprene base adhesive.

In order to properly adhere the components of heating unit 100 together with FASTBOND™, the interfacing surfaces should be clean and dry. With the surfaces prepared, a uniform coat of FASTBOND™ is applied to both interfacing surfaces. After applying, the FASTBOND™ is allowed to dry completely, which typically takes about 30 minutes. Once the FASTBOND™ on both surfaces is dry, the two FASTBOND™ coated surfaces are joined together.

For example, when attaching insulation layer 104 to heat spreading element 122, a coat of FASTBOND™ is applied to the top surface of insulation layer 104 and the bottom surface of heat spreading element 122 over the top of heat generating strip 114. Once the FASTBOND™ on each surface is dry, heat spreading element 122 is positioned on top of insulation layer 104 and the two layers of FASTBOND™ adhere to one another. The same process can be followed to attach second cover layer 108 to the top surface of heat spreading element 122 or to attach the first cover layer 102 to the bottom surface of insulation layer 104.

In the illustrated embodiment, second cover layer 108 is attached to heating element 106 and heating element 106 is attached to insulation layer 104. Notably, however, insulation layer 104 and heating element 106 can be left unattached from first and/or second cover layers 102 and 108. Not attaching insulation layer 104 and heating element 106 to first and/or second cover layers 102 and 108 provides for flexibility and give in heating unit 100 when heating unit 100 is folded, rolled, or wrapped around an object. Specifically, heating unit 100 is configured to be wrapped around an object such that second cover layer 108 is adjacent the object and first cover layer 102 is positioned away from the object (see FIG. 1 in which first cover layer 102 is showing). When first and/or second cover layers 102 and 108 are not attached to insulation layer 104 and/or heating element 106, first and/or second cover layers 102 and 108 are able to move relative to insulation layer 104 and heating element 106 and stretch as heating unit 100 is wrapped around an object. In other embodiments, however, insulation layer 104 and first cover layer 102 are attached to one another while heating element 106 and second cover layer 108 are attached to one another. For example, when heating unit 100 is used on flat surfaces, such as the ground or a roof, the need for first and second cover layers 102 and 108 to be able to move relative to insulation layer 104 and heating element 106 is not as great.

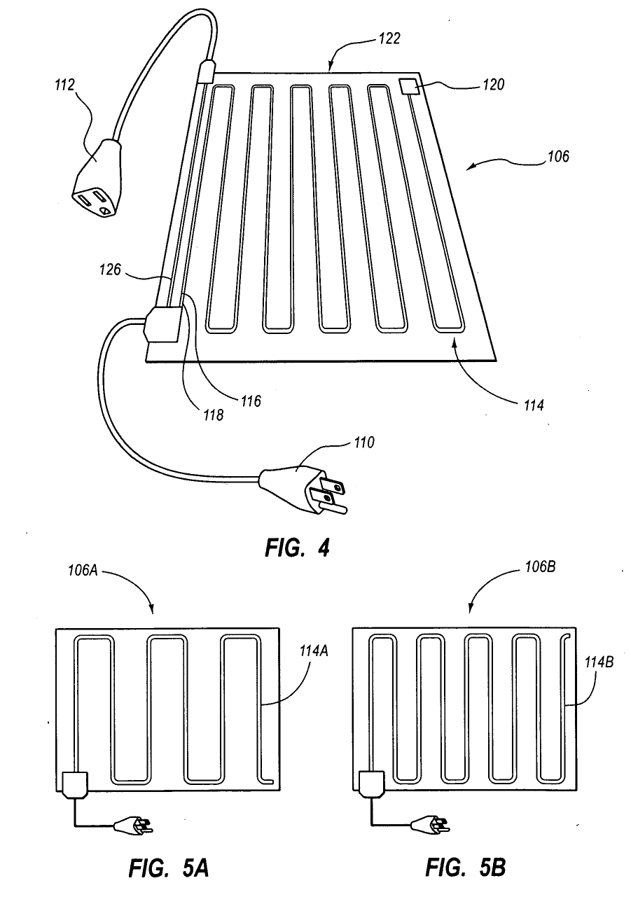

The following discussion will now treat additional details and embodiments of the various components of the heating unit 100. Referring now to FIG. 4 and as noted above, in some embodiments the heating element 106 includes a heat generating strip 114. The heat generating strip 114 may be, for example, an electro-thermal coupling material or resistive element. In some embodiments, the heat generating strip may be a copper, copper alloy or other conductor. In one embodiment, the conductor is a network of copper alloy elements configured to generate about 9 W of power per linear foot of the heat generating strip. This may be achieved by selection of appropriate alloys for the heat generating element 114 in combination with selection of appropriate heat generating element wire sizes and circuit configurations. The conductor may convert electrical energy to heat energy, and transfer the heat energy to the surrounding environment. Alternatively, the heat generating element 114 may comprise another conductor, such as semiconductors, ceramic conductors, other composite conductors, etc., capable of converting electrical energy to heat energy. The heat generating strip 114 may include one or more layers for electrical insulation, temperature regulation, and ruggedization.

Notably, other heat sources may be used in addition to or as alternatives to the heat generating strip. For example, some embodiments may include the use of exothermic chemical reactions to generate heat or heating tubes which a heated liquid runs through.

With continuing reference to FIG. 4, the heat generating strip 114 is illustrated with two heat generating conductors 116 and 118. One of the two conductors is connected to a first terminal of the incoming electrical connector 110 while the other conductor is connected to a second terminal of the electrical connector 110. The first and second terminals may be connected to electrical sources as appropriate, such as generator supplied AC or DC sources, batteries, power inverters, etc. The two conductors 116 and 118 may be connected at one end to create a closed circuit allowing current to flow through the two conductors to generate heat.

In the example illustrated in FIG. 4, the two conductors are connected through a thermostat 120. In this example, the thermostat 120 includes a bi-metal strip based temperature control that disconnects the two conductors 116 and 120 at a pre-determined temperature. Examples of predetermined temperatures may be 60° F., 80° F., 100° F., and 120° F. Notably, these are only examples, and other temperatures may be alternatively used. This can be used to regulate the temperature of the heating unit 100 to prevent overheating, or to maintain the temperature at a temperature of about the pre-determined temperature.

Embodiments may be implemented where the temperature is determined by selecting a thermostat 120 with a fixed temperature rating. Other embodiment may be implemented where the temperature setting of the thermostat can be adjusted to a predetermined temperature at manufacturing time. In some embodiments, the thermostat may be user accessible to allow a user to adjust the thermostat settings. While in the example illustrated the thermostat is located at the ends of the conductors 116 and 118, it should be appreciated that in other embodiments the thermostat may be placed inline with one of the conductors 116 and 118. Additionally, some embodiments may include low voltage control circuitry including temperature control functionality, which controls application of power to the conductors 116 and 118 to regulate temperature.

It should further be appreciated that embodiments may be implemented where other temperature or current protections are included. For example, embodiments may include magnetic and/or thermal circuit breakers, fuses, semiconductor based over-current protection, ground fault protection, arc fault protection, etc. In some embodiments, these may be located at the ends of the conductors 116 and 118 or inline with one or more of the conductors 116 and 118 as appropriate.

Additionally, controlling temperature may be accomplished by controlling the density of the heat generating element 114. This may be accomplished by controlling spacing between different portions of the heat generating element allowing for more or less material used for the heat generating element 114 to be included in the heating unit 100. This method may be especially useful when heat generating elements have a constant Wattage output per length of heat generating element. Thus a longer heat generating element 114 provides more heat than a shorter heat generating element 114. FIGS. 5A and 5B illustrate a comparative example where two alternative embodiments are illustrates. Each of the embodiments illustrates a heating unit 100 of the same size, but with different heat generating elements densities. The first embodiment illustrates a heating element 106A with a less dense heat generating element 114A, while the second embodiment illustrates a heating element 106B with a more dense heat generating element 114B.

By way of the method described herein, the temperature of propane tank 10 can be regulated. In particular, by way of a thermostat or the selection and configuration of the heating unit components, the temperature of the propane tank can be maintained at a desired temperature or within a desired temperature range. For example, when propane gas is used as a fuel supply, it is important to maintain the propane in its gaseous form. If the propane changes from a gas to a liquid, interruptions to the flow of the propane can be encountered. Thus, to prevent the propane from changing into its liquid form, the propane must be maintained above its boiling point temperature, which is approximately −43° F. Thus, the thermostats, configuration of the heating unit components, and the temperature protection mechanisms described herein enable a propane tank to be maintained above −43° F., at a desired temperature, or within a desired temperature range. By way of example, some desired temperatures may be 60° F., 80° F., and 110° F. Similarly, exemplary temperature ranges may be, for example, between 65° F. and 110° F., between 72° F. and 90° F., and between 75° F. and 85° F.

Returning attention to FIG. 4, as noted above, the electrical heating element 106 may further include a heat spreading element. In general terms, the heat spreading element 122 is a layer of material capable of drawing heat from the heat generating element 114 and distributing the heat energy away from the heat generating element 114. Specifically, the heat spreading element 122 may comprise a metallic foil, wire mesh, carbon mesh, graphite, a composite material, or other material.

The heat-spreading element 122 in one embodiment is an electrically-conductive material comprising carbon. Graphite is one example of an electrically-conductive material comprising carbon. However, other suitable materials may include carbon-based powders, carbon fiber structures, or carbon composites. Those of skill in the art will recognize that material comprising carbon may further comprise other elements, whether they represent impurities or additives to provide the material with particular additional features. Materials comprising carbon may be suitable so long as they have sufficient thermal conductivity to act as a heat-spreading element. In one embodiment, the material comprising carbon comprises sufficient electrical conductivity to act as a ground connection, as will be discussed in more detail below. The heat-spreading element 122 may further comprise a carbon derivative, or a carbon allotrope.

One example of a material suitable for a heat spreading element 122 is a graphite-epoxy composite. The in-plane thermal conductivity of a graphite-epoxy composite material is approximately 370 watts per meter per Kelvin, while the out of plane thermal conductivity of the same material is 6.5 watts per meter per Kelvin. The thermal anisotropy of the graphite/epoxy composite material is then 57, meaning that heat is conducted 57 times more readily in the plane of the material than through the thickness of the material. This thermal anisotropy allows the heat to be readily spread out from the surface which in turn allows for more heat to be drawn out of the heating element 114.

The heat spreading element 122 may comprise a material that is thermally isotropic in one plane. The thermally isotropic material may distribute the heat energy more evenly and more efficiently. One such material suitable for forming the heat spreading element 122 is GRAFOIL® available from Graftech Inc. located in Lakewood, Ohio. In particular, GRAFOIL® is a flexible graphite sheet material made by taking particulate graphite flake and processing it through an intercalculation process using mineral acids. The flake is heated to volatilize the acids and expand the flake to many times its original size. The result is a sheet material that typically exceeds 98% carbon by weight. The sheets are flexible, lightweight, compressibly resilient, chemically inert, fire safe, and stable under load and temperature. The sheet material typically includes one or more laminate sheets that provide structural integrity for the graphite sheet.

Due to its crystalline structure, GRAFOIL® is significantly more thermally conductive in the plane of the sheet than through the plane of the sheet. This superior thermal conductivity in the plane of the sheet allows temperatures to quickly reach equilibrium across the breadth of the sheet.

Typically, the GRAFOIL® will have no binder, resulting in a very low density, making the heated cover relatively light while maintaining the desired thermal conductivity properties. For example, the standard density of GRAFOIL® is about 1.12 g/ml. It has been shown that three stacked sheets of 0.030″ thick GRAFOIL® C have similar thermal coupling performance to a 0.035″ sheet of cold rolled steel, while weighing about 60% less than the cold rolled steel sheet.

Another product produced by GrafTech Inc. that is suitable for use as a heat spreading element 122 is EGRAF® SPREADERSHIELD™. The thermal conductivity of the SPREADERSHIELD™ products ranges from 260 to 500 watts per meter per Kelvin within the plane of the material, and that the out of plane (through thickness) thermal conductivity ranges from 6.2 down to 2.7 watts per meter per Kelvin. The thermal anisotropy of the material ranges from 42 to 163. Consequently, a thermally anisotropic planar heat spreading element 122 serves as a conduit for the heat within the plane of the heat spreading element 122, and quickly distributes the heat more evenly over a greater surface area than a foil. The efficient planar heat spreading ability of the planar heat spreading element 122 also provides for a higher electrical efficiency, which facilitates the use of conventional power supply voltages such as 120 volts on circuits protected by 20 Amp breakers, instead of less accessible higher voltage power supplies. In some embodiments, the heat spreading element 122 is a planar thermal conductor. In certain embodiments, the graphite may be between 1 thousandth of an inch thick and 40 thousandths of an inch thick. This range may be used because within this thickness range the graphite remains pliable and durable enough to withstand repeated rolling and unrolling as the heating unit 100 is unrolled for use and rolled up for storage.

The heat spreading element 122 may comprise a flexible thermal conductor. In certain embodiments, the heat spreading element 122 is formed in strips along the length of the heat generating element 114. In alternative embodiments, the heat spreading element 122 may comprise a contiguous layer.

In some embodiments, the heat spreading element 122 may also include functionality for conducting electrical energy and converting electric energy to thermal energy in a substantially consistent manner throughout the heat spreading element. Graphite heat spreading elements may be particularly well suited for these embodiments. In such an embodiment, a heat generating element 114 may be omitted from the heating unit 100 as the heat spreading element 122 serves the purposes of conveying current, producing heat due to resistance, and evenly distributing the heat.

The small size and thickness of the graphite minimizes the weight of the heat spreading element 122. The graphite containing heat spreading element may be pliable such that the graphite can be rolled lengthwise without breaking the electrical path through the graphite.

In some embodiments, the heat spreading element 122 may include an insulating element formed of a thin plastic layer on both sides of the heat-spreading element 122. The insulating element may additionally provide structure to the heat-spreading material used in the heat spreading element 122. For example, the insulating element may be polyethylene terephthalate (PET) in the form of a thin plastic layer applied to both sides of heat-spreading element 122 comprising graphite. Those of skill in the art will appreciate that such a configuration may result in the insulating element lending additional durability to the heat-spreading element 122 in addition to providing electrical insulation, such as electrical insulation from the electrical current in the heat generating element 114. It should be noted that the heating generating element 114 may include its own electrical insulation as well as described above.

In some embodiments, the heat spreading element 122 may include a heat conducting liquid such as water, oil, grease, etc.

In certain embodiments, the heat generating element 114 is in direct contact with the heat spreading element 122 to ensure efficient thermo-coupling. Alternatively, the heat spreading element 122 and the heat generating element 114 are integrally formed. For example, the heat spreading element 122 may be formed or molded around the heat generating element 114. Alternatively, heat generating strip 114 and the heat spreading element 122 may be adhesively coupled.

Notably, while temperature may be controlled with the use of thermostats as described above, other embodiments may implement other design criteria to control temperature. For example, some embodiments may use appropriate selection of the heat spreading element 122 and/or the arrangement of the heat generating element 114. Illustratively, the heat retention properties of the heat spreading element 122 may be a factor in regulating temperatures at which a heating unit 100 will operate. Further, the density of the heat generating element 114 with respect to the size of the heating unit 100 or the heat spreading element 122 can be used set the operating temperatures or to regulate temperatures.

In some embodiments, the heating unit is sized to substantially enclose a 20 pound propane tank. Other embodiments may be sized to wrap around a 40 or a 100 pound propane tank. For example, a heating unit may be about twelve (12) inches by twelve (12) inches to substantially enclose a 20 pound propane tank. Alternatively, a unit for a 40 pound propane tank may be about fifteen (15) inches by eighteen (18) inches. It will be appreciated, however, that the heating unit can be sized and configured to substantially enclose propane tanks of any size or shape.

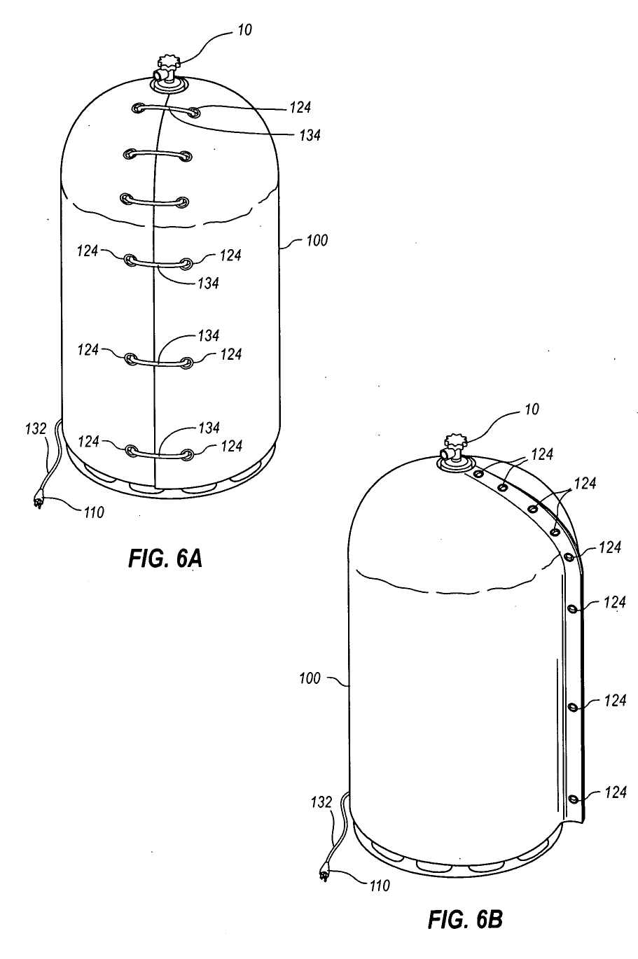

Returning once again to FIGS. 2 and 3, FIGS. 2 and 3 illustrate an insulating layer 104. The insulating layer 104 may be used to reflect or direct heat or to prevent heat from exiting in an undesired direction. For example, it may be desirable to have all or most of the generated heat be directed towards a particular surface of the heating unit 100. In the embodiment illustrated in FIGS. 1, 6A, and 6B, for example, it may be desirable to direct heat towards the wall of the propane tank 10 while directing heat away from an exterior environment in which the propane tank is located. In the example illustrated, it may be desirable to have heat directed towards the side of the heating unit 100 which includes the second cover layer, while directing heat away from the side that includes the first cover layer. The insulating layer 104 may be used to accomplish this task. Some exemplary embodiments of the heating unit have been implemented where about 95% of heat generated is directed towards a desired surface of the heating unit.

The insulating layer 104 may include a sheet of polystyrene, cotton batting, GORE-TEX®, fiberglass, foam rubber, etc. In certain embodiments, the insulating layer 104 may allow a portion of the heat generated by the heat generating element 114 to escape the top of the second cover layer 108 if desired. For example, the insulating layer 104 may include a plurality of vents to transfer heat to the second cover layer 108. In certain embodiments, the insulating layer 104 may be integrated with either the first cover layer 102 or the second cover layer 108. For example, the first cover layer 102 may include an insulation fill or batting positioned between two films of nylon.

In some embodiments, first and second cover layers 102 to 108 may comprise a textile fabric. The textile fabric may include natural or synthetic products. For example, the first and second cover layers 102 to 108 may comprise burlap, canvas, cotton or other materials. In another example, first and second cover layers 102 to 108 may comprise nylon, vinyl, or other synthetic textile material. The first and second cover layers 102 to 108 may comprise a thin sheet of plastic, metal foil, polystyrene, or other materials.

In manufacturing the heating unit 100, the heating element 106 and insulation layer 104 may be sealed between the first and second cover layers 102 and 108. As illustrated in FIGS. 2 and 3, the first and second cover layers 102 and 108 extend slightly beyond the heating element 106 and insulation layer 104. This allows the first and second cover layers 102 and 108 to be sealed, such as by using an adhesive, heat welding, or another other appropriate method or combination of methods.

Additionally, the heating unit 100 may be constructed such that the first and second cover layers 102 and 108 may include one or more fasteners 124 for securing or connecting the heating unit 100. In some embodiments, the fasteners 124 may be attached or formed into the corners of the heating unit 100. Additionally, fasteners 124 may be distributed about the perimeter of the heating unit 100. In some embodiments, the fastener 124 is a hook and loop fastener such as VELCRO®. For example, the heating unit 100 may include a hook fabric on one side and a loop fabric on an opposite side. In other alternative embodiments, the fastener 124 may include grommets, snaps, zippers, adhesives, or other fasteners. Further, additional objects may be used with the fasteners to accomplish fastening. For example, when grommets are used, elastic cord, such as fixed or adjustable bungee cord may be used to connect to grommets on opposite sides of the heating unit 100. This may be used, for example, to securely wrap the heating unit around an object, such as a propane tank.

FIGS. 1, 6A, and 6B illustrate a number of fastener arrangements that may be implemented. For example, FIG. 1 illustrates a first portion of the heating unit 100 overlapping an opposing portion of the heating unit 100, and being attached to the opposing portion by snap fasteners 124. FIG. 6A illustrates a first portion of the heating unit 100 overlapping an opposing portion of the heating unit 100. Grommet fasteners 124 are secured to the opposing portions of the heating unit 100 and set away from the edges of the heating unit 100 such that elastic cords 134 can be used to secure the opposing portions. FIG. 6B illustrates an example where opposing portions of the heating unit 100 are permanently fastened. In this case, grommet fasteners 124 are secured to opposing portions, where a single grommet may be secured to both opposing portions such that the heating unit permanently maintains a substantially wrapped shape.

FIGS. 6A and 6B also illustrate alternative embodiments for closing at least one of the end portions of heating unit 100 around at least one of the ends of propane tank 10. In FIG. 6A, a first section of the closable end portion overlaps a second section of the closable end portion. Grommet fasteners 124 are secured to the two sections of the closable end portion such that elastic cords 134 can be used to secure the section together. FIG. 6B illustrates an example where opposing sections of the closable end portion are permanently fastened. In this case, grommet fasteners 124 are secured to opposing section, where a single grommet may be secured to both opposing section such that the end portion of heating unit 100 permanently maintains a substantially dome shape that generally corresponds to the end shape of propane tank 10.

In some embodiments, the first cover layer 102 may be positioned at the top of the heating unit 100 and the second cover layer 108 may be positioned on the bottom of the heating unit 100. In certain embodiments, the first cover layer 102 and the second cover layer 108 may comprise the same or similar material. Alternatively, the first cover layer 102 and the second cover layer 108 may comprise different materials, each material possessing properties beneficial to the specified surface environment.

For example, the first cover layer 102 may comprise a material that is resistant to sun rot such as such as polyester, plastic, and the like. The second cover layer 108 may comprise material that is resistant to mildew, mold, and water rot such as nylon. The cover layers 102 and 108 may comprise a highly durable material. The material may be textile or sheet, and natural or synthetic. For example, the cover layers 102, 108 may comprise a nylon textile. Additionally, the cover layers 102, 108 may be coated with a water resistant or waterproofing coating. For example, a polyurethane coating may be applied to the outer surfaces of the cover layers 102, 108. Additionally, the top and bottom cover layers 102, 108 may be colored, or coated with a colored coating such as paint. In some embodiments, the color may be selected based on heat reflective or heat absorptive properties. For example, the top layer 102 may be colored black for maximum solar heat absorption. The bottom layer 102 may be colored grey for a high heat transfer rate or to maximize heat retention beneath the cover.

As illustrated in FIGS. 1, 2, 6A, and 6B, the heating unit can also include one or two closable end portions that are adapted to direct the heat generated by the heating unit toward the propane tank. At one end of the heating unit 100 illustrated in FIG. 2, the top and bottom cover layers 102, 108 and the insulating layer 104 extend beyond the heating element 106. Additionally, the top and bottom cover layers 102, 108 and the insulating layer 104 can include cutouts 146. Cutouts 146 are configured to enable the ends of heating unit 100 to readily close and generally conform to the shape of propane tank 10. While the illustrated embodiment does not include heating element 106 in the closable end portion of heating unit 100, it will be appreciated that heating element 106 can also extend into the closable end portions of heating unit 100.

In the embodiment illustrated in FIGS. 1 and 2, the closable end portion includes a draw string 142 that extends through a draw string channel 144 in the end of heating unit 100. The draw string channel 144 can be formed in one or both of top and bottom cover layers 102, 108. Alternatively, draw string channel 144 can be formed by both top and bottom cover layers 102, 108 when top and bottom cover layers 102, 108 are secured, attached, or otherwise coupled together.

As described herein, heating unit 100 can be wrapped and secured around the outer wall of a propane tank 10. With the heating unit 100 so positioned on the propane tank 10, draw string 142 can be pulled to draw in the end of heating unit 100 so as to substantially enclose the end of propane tank 10. While not illustrated, it will be appreciated that heating unit 100 can be formed with a closable end portion on each end of heating unit 100 so that both ends of propane tank 10 can be enclosed by heating unit 100. For propane tanks with a valve assembly on an end thereof as illustrated in FIGS. 1, 6A, and 6B, the closable end portion can be configured to close around the sides of the valve assembly, or enclose the valve assembly within heating unit 100. In this manner, insulating layer 104 is able to trap the heat generated by heating unit 100 near propane tank 10, thereby reducing the amount of energy required to warm propane tank 10.

The embodiment shown in FIGS. 1-3 includes a six (6) foot power cord 132 connected to the heat generating element 114. Other cord lengths may also be implemented within the scope of embodiments of the invention. The power cord may additionally be connected to an incoming electrical connector 110 such as an AC power plug, bare wire connector, alligator clip connectors, a cigarette lighter plug connector or other appropriate connector for connecting the power cord to a source of power.

Notably, some embodiments may be implemented with interchangeable incoming electrical connectors. For example, embodiments may include a kit which includes a heating unit 100 with a two pin auto connector. The kit may further include a wire without an additional connector connected to a mating two pin auto connector, a set of alligator clips connected to a mating two pin auto connector, and a cigarette lighter plug connected to a mating two pin auto connector. A user can then select an appropriate incoming electrical connector 110. For example, a user may select the wire without an additional connector if the heating unit is to be hard wired to an electrical system, such as an automobile, boat, or other electrical system. Cigarette lighter plugs or alligator clip connectors could be selected for more temporary connectors.

Some embodiments may also include various fault protections. For example, embodiments may include an incoming electrical connector 110 which includes ground fault circuit interruption capabilities so as to make the heating unit 100 suitable for use in wet or outdoor environment. Embodiments may include over current protection such as breakers or fuses. Embodiments may include arc fault circuit interruption capabilities to address problems related to fatigue of wires or crushing of wires.

Embodiments may further include provisions for grounding the heating unit 100. For example, the heating unit is illustrated in FIGS. 1-3 includes an incoming electrical connector in the form an AC plug, which includes two power terminals 128 and a grounding terminal 130. The power cord 132 may include three conductors, one connected to each power terminal 128, and the third connected the grounding terminal 130. The two conductors connected each to a respective power terminal 128 connect as described above to the heat generating element 114. The third conductor may be connected so as to ground the heating unit 100. This may be done, for example by including an electrically conductive layer (not shown) in the heating unit 100 which is electrically connected to the grounding terminal 130.

In an alternative embodiment, due to the electrically conductive nature of the heat spreading element 122 when a graphite based material is used for the heat spreading element 122, the grounding terminal 130 may be electrically coupled to the heat spreading element 122. This may be accomplished in one example, by using a ground coupling in the form of a spade connector or other connector which passes through a protective layer of the heat spreading element so as to be in electrical contact with the conductive portions of the heat spreading element 122. In one embodiment, the ground couplings comprise planar rectangular metal connection blades that would normally be used as the hot and/or neutral connection blades of a power coupling such as a power coupling which connects to a power source. In one embodiment, ground coupling spade connector further comprises barbs configured to cut into the heat-spreading element 122 and engage the heat-spreading element 122 such that the blade does not come loose. In alternative embodiments, the blade may be connected to the heat-spreading element 122 with an adhesive that does not electrically insulate the heat-spreading element 122 from the blade. In addition, the plane of the blade may be placed parallel to the plane of the heat-spreading element 122 such that a maximum amount of the surface area of the blade is in direct contact with the heat-spreading element 122. Such a configuration may increase the contact area between the two surfaces and results in a better electrical and physical connection. Furthermore, such a configuration can leverage the lower in-plane resistivity of the heat-spreading element 122.

Additionally, some embodiments may include an outgoing electrical connector 112. This may be used, for example to allow chaining of heating units together. In the example illustrated, the outgoing electrical connector 112 is connected electrically to the incoming electrical connector 110 through conductors 126 passing through the heating unit 100. Other embodiments may allow the incoming electrical connector 110 and outgoing electrical connector 112 to be more or less proximate to each other as appropriate.

A grounding terminal 132 of the outgoing electrical connector 112 may be electrically connected to the grounding terminal 130 of the incoming electrical connector 110. This may be accomplished by wiring the two terminals together or connecting both grounding connectors to the same grounding surface, such as a grounding layer, or to the heat spreading element 122 as described above.

Some embodiments may further include timing circuitry such that a user can select when heating should occur. The timer may be an electronic controlled device supplied by the electrical connector 112 and may include internal switching such as relays or solid state switches for supplying power to the heat generating strip 114.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A heating unit for use in heating a propane tank, the heating unit comprising:
a first pliable cover layer;
a second pliable cover layer;
a pliable electrical heating element disposed between the first and the second cover layers, the electrical heating element comprising:
a heat generating element for converting electrical energy to heat energy; and
a heat spreading element attached to the heat generating element, the heat spreading element comprising carbon thermally coupled to the heat generating element for distributing the heat energy;
a thermal insulation layer attached to a first side of the electrical heating element with an adhesive and positioned adjacent the first cover layer;
a receiving power connector electrically connected to the heat generating element, the receiving power connector configured to couple to an electrical power source;
one or more fasteners disposed in the first and second pliable cover layers to enable the heating unit to be wrapped and secured around a propane tank;
a thermally insulated end portion having a closure mechanism that enables the end portion to be closed and substantially cover an end of the propane tank; and
wherein the heating unit is sized to cover substantially the entire outer wall circumference and at least one end of the propane tank.

2. The heating unit of claim 1, wherein a second side of the electrical heating element is attached to the second cover layer with an adhesive.

3. The heating unit of claim 1, wherein the heat generating element and the thermal insulation layer are attached to the same side of the heat spreading element.

4. The heating unit of claim 1, wherein the thermal insulation layer is attached to the first pliable cover layer.

5. The heating unit of claim 1, wherein the thermally insulated end portion comprises the first pliable cover layer, the second pliable cover layer, and the thermal insulation layer disposed therebetween.

6. The heating unit of claim 1, wherein the closure mechanism in the end portion comprises a draw string.

7. The heating unit of claim 1, wherein the closure mechanism in the end portion comprises the one or more fasteners.

8. The heating unit of claim 7, wherein the one or more fasteners comprise grommets, snaps, draw strings, or a combination thereof.

9. The heating unit of claim 1, further comprising a second thermally insulated end portion having a closure mechanism that enables the second end portion to be closed and substantially cover a second end of the propane tank.

10. The heating unit of claim 1, wherein the heating unit is sized to substantially cover a 20 pound, a 40 pound, or a 100 pound propane tank.

11. A method of heating a propane tank, the method comprising:
wrapping a pliable electrical heating unit around a propane tank;
securing the pliable electrical heating unit around the propane tank; and
closing an end portion of the pliable electrical heating unit around an end of the propane tank, wherein the heating unit is sized to cover substantially the entire outer circumference of the entire propane tank and at least one end of the propane tank, and wherein the pliable electrical heating unit comprises:
a heat generating element for converting electrical current to heat energy;
a heat spreading element attached to the heat generating element, the heat spreading element comprising carbon, wherein the heat spreading element is thermally coupled to the heat generating element;
a thermal insulation layer attached to the heat spreading element;
first and second cover layers disposed on opposing sides of the heat generating element, heat spreading element, and the thermal insulation layer;
one or more fasteners configured to enable the heating unit to be wrapped and secured around the propane tank; and
a closure mechanism configured to enable the end portion to be closed and substantially cover an end of the propane tank.

12. The method of claim 11, further comprising thermally and electrically connecting to the heating element a thermostat configured to regulate an operating temperature of the heating element.

13. The method of claim 12, further comprising manually setting the thermostat to a predetermined temperature.

14. The method of claim 11, further comprising electrically connecting a timer configured to control when the heating unit supplies heat energy.

15. A heating unit for use in heating a propane tank, the heating unit comprising:
a first pliable cover layer and a second pliable cover layer associated with one another to form an envelope with an interior portion;
a pliable electrical heating element disposed within the interior portion of the envelope formed by the first and second cover layers, wherein a first side of the electrical heating element is positioned adjacent to an interior surface of the second cover layer, the electrical heating element comprising:
a heat generating element for converting electrical energy to heat energy; and
a heat spreading element attached to the heat generating element with an adhesive, the heat spreading element comprising carbon thermally coupled to the heat generating element for distributing the heat energy;
a thermal insulation layer disposed within the envelope formed by the first and second cover layers, wherein a first side of the thermal insulation layer is attached to a second side of the electrical heating element with an adhesive, and wherein a second side of the thermal insulation layer is positioned adjacent an interior surface of the first cover layer;
a receiving power connector electrically connected to the heat generating element, the receiving power connector configured to couple to an electrical power source;
one or more fasteners configured to secure the heating unit around the propane tank; and
wherein the first pliable cover layer, the second pliable cover layer, and the thermal insulation layer form a thermally insulated end portion, the thermally insulated end portion having a closure mechanism that enables the end portion to be closed and substantially cover an end of the propane tank; and
wherein the heating unit is sized to cover substantially the entire outer wall circumference and at least one end of the propane tank.

16. The heating unit of claim 16, wherein the heat spreading element comprises graphite.

17. The heating unit of claim 15, wherein the heating unit is adapted to maintain the propane tank within a predetermined temperature range.

18. The heating unit of claim 17, wherein the predetermined temperature range is between 70° F. and 110° F.

19. The heating unit of claim 15, wherein the thermal insulation layer comprises cutouts to facilitate closer of the thermally insulated end portion of the heat unit around an end of the propane tank.

20. The heating unit of claim 15, wherein the closure mechanism of the thermally insulated end portion comprises a draw string, grommets, snaps, a hoop and loop fastening system, or a combination thereof.
